(19) United States
(12) Patent Application Publication
(10) Pub. No.: US 2025/0193790 A1
(43) Pub. Date: Jun. 12, 2025

(54) POWER SAVING OPERATIONS FOR RELAY NETWORKS

(71) Applicant: Samsung Electronics Co., Ltd., Suwon-si (KR)

(72) Inventors: Rubayet Shafin, Frisco, TX (US); Yue Qi, Plano, TX (US); Boon Loong Ng, Plano, TX (US); Peshal Nayak, Plano, TX (US); Vishnu Vardhan Ratnam, Plano, TX (US)

(21) Appl. No.: 18/945,427

(22) Filed: Nov. 12, 2024

Related U.S. Application Data
(60) Provisional application No. 63/607,010, filed on Dec. 6, 2023.

(51) Int. Cl. H04W 52/02; H04W 88/04

(52) U.S. Cl. CPC H04W 52/0216; H04W 88/04

(57) ABSTRACT

A first station (STA) in a wireless network, comprising a memory and a processor coupled to the memory, the processor configured to transmit, to a second STA, a first frame that requests the second STA operate as a relay node that relays communication between the first STA and a third STA; receive, from the second STA, a second frame that accepts the request in the first frame; transmit, to the second STA, a third frame that includes a request for a setup of a target wake time (TWT) schedule or a TWT agreement between the first STA and the second STA; receive, from the second STA, a fourth frame that accepts the request in the third frame; and transmit, to the third STA via the second STA, one or more frames based on the TWT schedule or the TWT agreement established between the first STA and the second STA.

### CROSS-REFERENCE TO RELATED APPLICATION(S)

This application claims the benefit of priority from U.S. Provisional Application No. 63/607,010, entitled “POWER SAVING OPERATION FOR RELAY NETWORKS” filed Dec. 6, 2023, which is incorporated herein by reference in its entirety.

### TECHNICAL FIELD

This disclosure relates generally to a wireless communication system, and more particularly to, for example, but not limited to, peer-to-peer (P2P) resource management in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network, comprising: a memory; and a processor coupled to the memory. The processor is configured to transmit, to a second STA, a first frame that requests the second STA operate as a relay node that relays communication between the first STA and a third STA. The processor is configured to receive, from the second STA, a second frame that accepts the request in the first frame. The processor is configured to transmit, to the second STA, a third frame that includes a request for a setup of a target wake time (TWT) schedule or a TWT agreement between the first STA and the second STA. The processor is configured to receive, from the second STA, a fourth frame that accepts the request in the third frame. The processor is configured to transmit, to the third STA via the second STA, one or more frames based on the TWT schedule or the TWT agreement established between the first STA and the second STA.

In some embodiments, the third frame includes a TWT element that includes one or more parameters of the TWT schedule or the TWT agreement that the first STA intends to establish for communication with the third STA via the second STA.

In some embodiments, the TWT schedule is aligned with another TWT schedule that is established between the second STA and the third STA.

In some embodiments, TWT parameters for the TWT schedule and the another TWT schedule are the same.

In some embodiments, TWT parameters for the TWT schedule and the another TWT schedule are different.

In some embodiments, the processor is further configured to abstain from transmitting any frames to the third STA via the second STA during a doze state of the TWT schedule or the TWT agreement.

One aspect of the present disclosure provides a first station (STA) in a wireless network, comprising: a memory; and a processor coupled to the memory. The processor is configured to receive, from a second STA, a first frame that requests the first STA operate as a relay node that relays communication between the second STA and a third STA. The processor is configured to transmit, to the second STA, a second frame that accepts the request in the first frame. The processor is configured to receive, from the second STA, a third frame that includes a request for a setup of a target wake time (TWT) schedule or a TWT agreement between the second STA and the first STA. The processor is configured to transmit, to the second STA, a fourth frame that accepts the request in the third frame. The processor is configured to relay, to the third STA, one or more frames received from the second STA based on the TWT schedule or the TWT agreement established between the first STA and the second STA.

In some embodiments, the third frame includes a TWT element that includes one or more parameters of the TWT schedule or the TWT agreement that the second STA intends to establish for communication with the third STA via the first STA.

In some embodiments, the processor is further configured to transmit, to the third STA, a fifth frame that include a request of a setup of another TWT schedule or another TWT agreement between the first STA and the third STA, receive, from the third STA, a sixth frame that accepts the request in the fifth frame, and transmit, to the third STA, one or more frames based on the another TWT schedule or the another TWT agreement.

In some embodiments, the TWT schedule is aligned with the another TWT schedule.

In some embodiments, TWT parameters for the TWT schedule and the another TWT schedule are the same.

In some embodiments, TWT parameters for the TWT schedule and the another TWT schedule are different.

In some embodiments, the processor is further configured to: receive, from the second STA, a fifth frame that includes a request of a setup of another TWT schedule or another TWT agreement between the second STA and the first STA for uplink (UL) or downlink (DL) operation; transmit, to the second STA, a sixth frame that accepts the request in the fifth frame; transmit, to the second STA, one or more frames based on the another TWT schedule or another TWT agreement for UL or DL operation.

In some embodiments, the processor is further configured to abstain from transmitting any frames to the third STA during a doze state of the TWT schedule or the TWT agreement.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example of a typical infrastructure network in accordance with an embodiment.

FIG. 5 illustrates an example of a network with STAs suffering from low signal-to-noise ratio (SNR) or signal strength in accordance with an embodiment.

FIG. 6 illustrates a relay node operation in accordance with an embodiment.

FIG. 7 illustrates a relay node's coordination with an STA's power saving schedule in accordance with an embodiment.

FIG. 8 illustrates usage of TWT as a power saving schedule between a relay node and the source/destination node in accordance with an embodiment.

FIG. 9 illustrates usage of separate power saving schedules for relaying operation and uplink (UL) and downlink (DL) operation in accordance with an embodiment.

FIG. 10 illustrates setting up a power saving schedule between a STA and a relay node in accordance with an embodiment.

FIG. 11 illustrates aligned schedule setup for relay operation in accordance with an embodiment.

FIG. 12A shows an example of a TWT element in accordance with an embodiment.

FIG. 12B illustrates another example of a TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

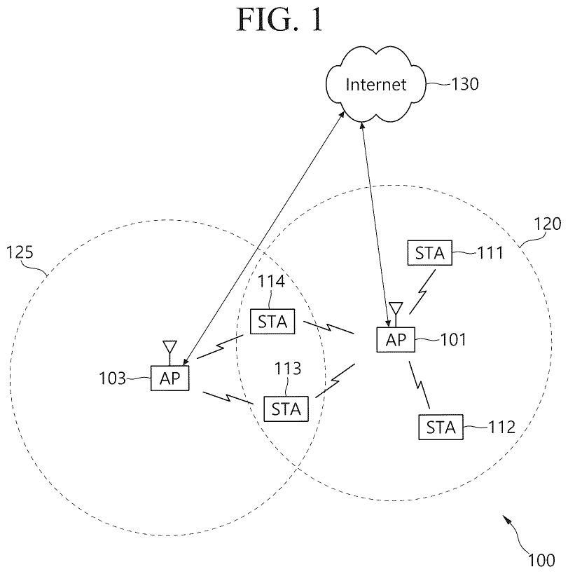

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

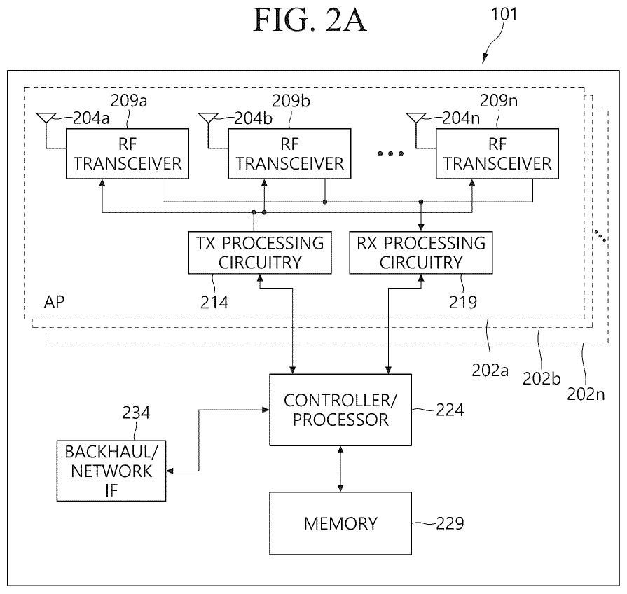

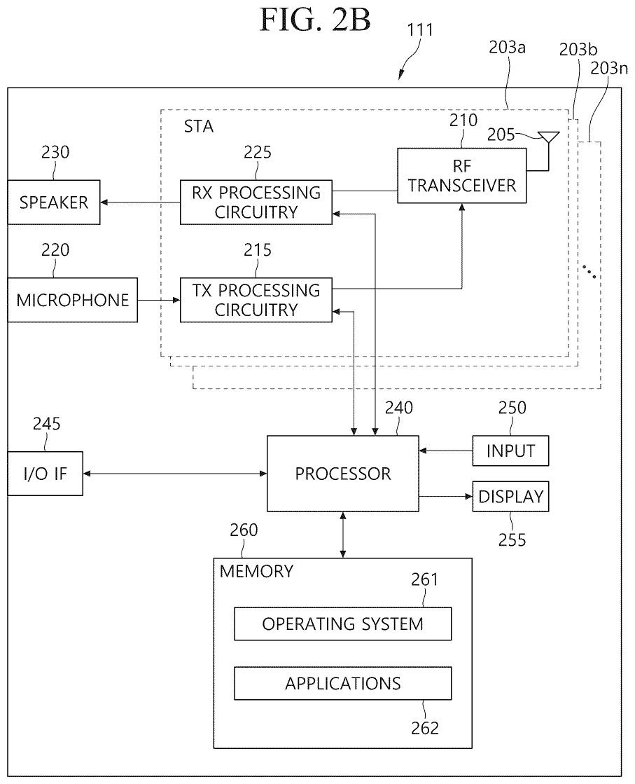

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

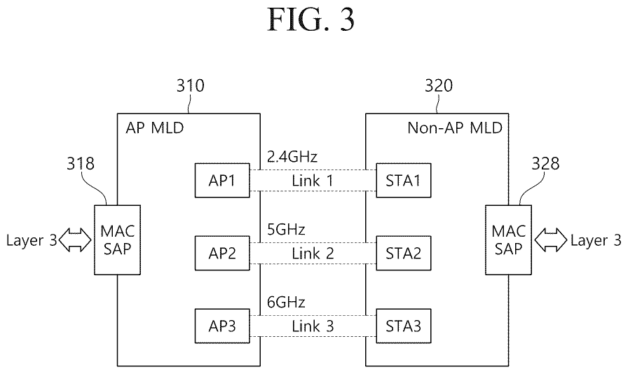

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11bc/D4.0, “Wireless LAN Medium Access Control (MAC) and Physical Layer (PHY) Specifications.”

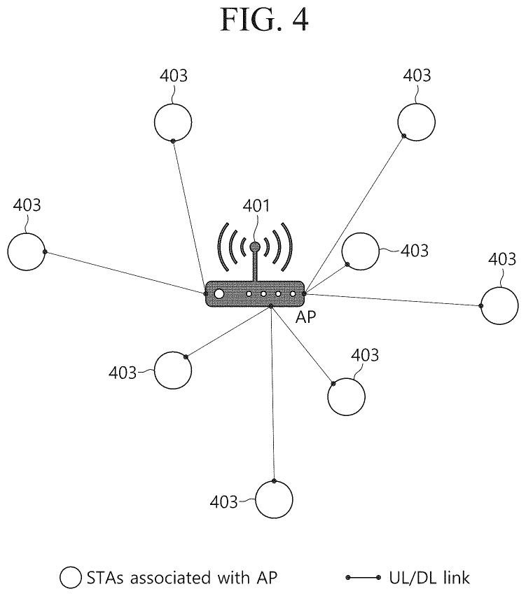

FIG. 4 shows an example of a typical infrastructure network in accordance with an embodiment. The network depicted in FIG. 4 is for explanatory and illustration purposes. FIG. 4 does not limit the scope of this disclosure to any particular implementation. In FIG. 4, a plurality of STAs 403 are non-AP STAs associated with AP 401. Additionally, solid lines between STAs and AP 401 represent uplink or downlink with AP 401. In a WLAN system, communication between an AP and any associated STAs takes place over the link between the AP and the associated STAs. For example, frame transmission and reception happens directly between the AP and the STA.

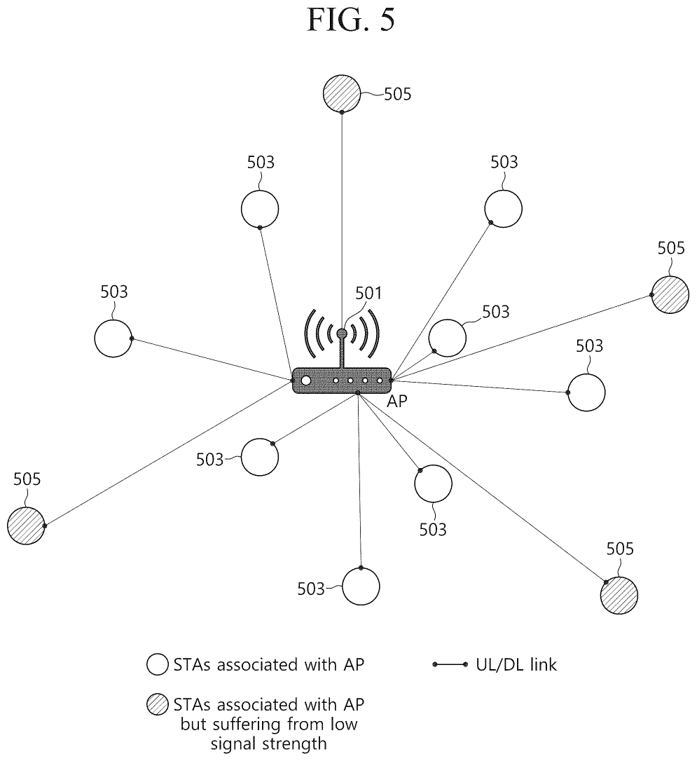

In a WLAN network, if a STA is located far away from its associated AP, the direct path between the AP and the STA may not be able to achieve sufficient signal strength (RSSI) to ensure a required quality of service (QoS). For example, the STA may be located within a network's periphery or cell edge, among various other reasons, whereby a user may experience a poor QoS due to system performance degradation. The issue is illustrated in FIG. 5 in accordance with an embodiment.

FIG. 5 illustrates an example of a network with STAs suffering from low signal-to-noise ratio (SNR) or signal strength in accordance with an embodiment. As illustrates, the network includes a plurality of STAs associated with an AP 501. Additionally, the lines between STAs and AP 501 represent uplink or downlink with AP 501. The STAs include a plurality of STAs 503 associated with the AP 501 and a plurality of STAs 505 associated with the AP 501 but suffering from low signal strength. The STAs 505 suffering from the low signal strength tend to be positioned further away from the AP 501.

Embodiments in accordance with this disclosure may increase the signal to noise ratio (SNR) for STAs that may be suffering from bad signal strength in order to improve their throughput and rate. Some embodiments may use relays to address potential signal strength issues.

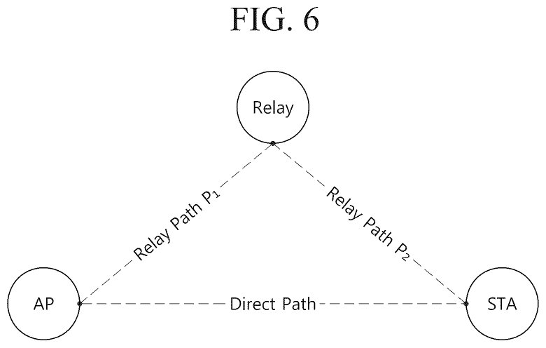

FIG. 6 illustrates a relay node operation in accordance with an embodiment. In FIG. 6, the STA is associated with the AP. However, the signal strength over the direct path between the AP and the STA is poor. Accordingly, a Relay node is placed between the AP and the STA. Therefore, the AP and the STA can now communicate with each other through the Relay node. For example, if the AP intends to transmit a frame or a Physical Layer Protocol Data Unit (PPDU) to the STA, the AP can transmit the PPDU to the Relay node first over the Relay Path P₁, and then the Relay node can forward the PPDU to the STA over the Relay Path P₂. Similarly, if the STA intends to transmit a PPDU to the AP, the STA can send the PPDU to the Relay node first over the Relay Path P₂, and then the relay node can forward the PPDU to the AP over the Relay Path P₁.

In some embodiments, a relay node can be wall-powered. In some embodiments, the relay node can be connected to an Alternating Current (AC) power source. In some embodiments, the relay node can be battery powered. In some embodiments, the relay node can be portable and can be wall-powered and/or battery-powered based on the operating conditions. In some embodiments, when a relay node is battery-powered, it can have power-saving needs so that it can operate for longer time on the battery.

In some embodiments, the relay node may not have its own power save (PS) requirements. However, to coordinate with the end users (e.g., STA and AP), the relay nodes may need to support a power saving schedule.

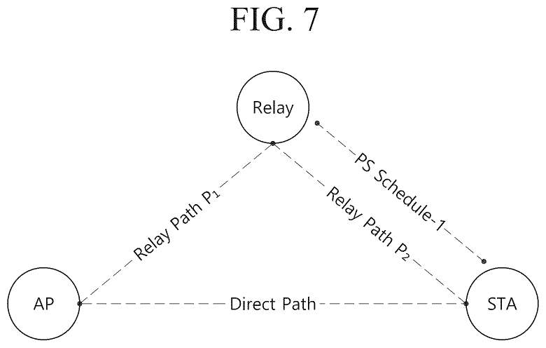

FIG. 7 illustrates a relay node's coordination with an STA's power saving schedule in accordance with an embodiment. In particular, FIG. 7 illustrates an STA, STA1, associated with an AP, and a Relay node which may be placed between the AP and the STA. The AP and the STA can communicate with each other through the Relay node via Relay Path P P₁ and Relay Path P₂. In FIG. 7, the Relay node may coordinate with the power-saving schedule of STA1. For example, the Relay node may not transmit any frames to STA1 during the doze state period of STA1. The doze state period of STA1 may be set by the power saving schedule, illustrated as PS-schedule-1 in FIG. 7, of STA1.

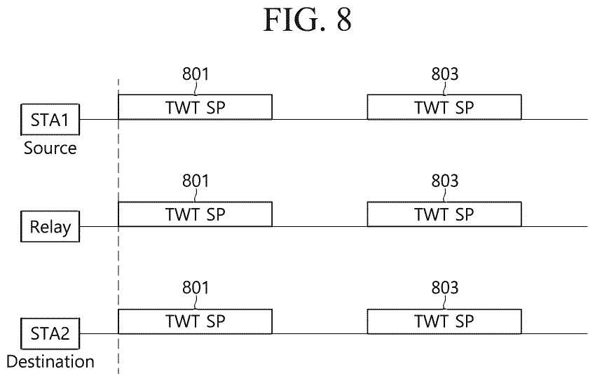

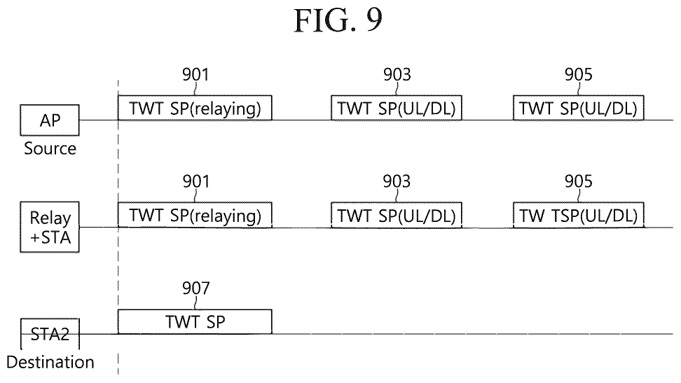

In some embodiments, a relay node can set up or negotiate a power saving schedule with a source node or a destination node. In some embodiments, the power saving schedules that the relay node establishes with a source node (e.g., an AP) and a destination node (e.g., a non-AP STA) can be aligned or synchronized. This can ensure that both the relay node and the source node or the destination node wake up at the same time. In some embodiments, a target wake time (TWT) schedule or TWT agreement can be established between the relay node and the source node or the destination node for power save. In some embodiments, an aligned TWT schedule or an aligned TWT agreement can be used to synchronize the TWT schedules or TWT agreements, which is explained in FIGS. 8 and 9.

FIG. 8 illustrates am example of a power saving schedule between a relay node, a source node, and a destination node in accordance with an embodiment. In particular, FIG. 8 illustrates a source node (STA1), a relay node (Relay), and a destination node (STA2). All of STA1, Relay node, and STA2 may have aligned TWT Service Periods (SPs) for communications. As illustrated in FIG. 8, the TWT SP 801 is aligned at a first time for STA1, Relay, and STA2. Likewise, the TWT SP 803 is aligned at a second later time for STA1, Relay, and STA2.

In some embodiments, a relay node can have traffic destined for itself (e.g., from the AP) as well as traffic destined for another STA. In such cases, the relay node can have separate schedules for uplink (UL) and downlink (DL) operations with its associated AP, and relaying operation with another STA. For example, the relay node can have a TWT schedule or TWT agreement established that it uses for relaying operation and another TWT schedule or TWT agreement that it uses for UL and DL operation with the AP.

FIG. 9 illustrates another example of power saving schedules among a relay node, source node, and destination node in accordance with an embodiment. In particular, FIG. 9 illustrates a source node (AP), a relay node (Relay+STA), and a destination node (STA2). The AP may have a separate schedule for UL and DL operations with the relay node (Relay+STA), and another schedule for relaying operations with the relay node (Relay+STA). In particular, the AP has a TWT SP (relaying) 901, a TWT SP (UL/DL) 903 at a first time, and a TWT SP (UL/DL) 905 at a second later time. The relay node (Relay+STA) may have separate schedules for UL and DL operations with its associated AP, and relaying operation with STA2. As illustrated in FIG. 9, the relay node (Relay+STA) has a TWT SP (relaying) 901 for relaying operations with STA2 and a TWT SP (UL/DL) 903 for UL and DL operations at a first time and a TWT SP (UL/DL) 905 for UL and DL operations at a second later time with its associated AP. As illustrated, the TWT SP (relaying) 901 for the AP and the relay node (Relay+STA) is aligned, the TWT SP (UL/DL) 903 is aligned at a first time for the AP and the relay node (Relay+STA), and the TWT SP (UL/DL) 905 is aligned at a second time for the AP and the relay node (Relay+STA). The STA2 has a TWT SP 907 that is aligned with the TWT SP (relaying) 901. Accordingly, a node may have a TWT schedule that is used for relaying operations and another TWT schedule that is used for UL and DL operations.

In some embodiments, a first STA may intend to transmit to a second STA via a third STA, where the third STA acts as a relay node between the first STA and the second STA. If the first STA intends to establish a power saving schedule for this communication, the first STA can send a power saving schedule request to the third STA (the relay node). The power-saving schedule request frame may include parameters for information pertaining to the power-saving schedule that the first STA intends to establish for communication via the relay node.

In some embodiments, a first STA may intend to transmit to a second STA via a third STA, where the third STA acts as a relay node between the first STA and the second STA. If the first STA intends to establish a TWT schedule for this communication, the first STA can include a TWT element in the request frame that it transmits to the third STA (e.g., the relay node). The TWT element may include parameters for information pertaining to the TWT schedule that the first STA intends to establish for communication via the relay node.

In some embodiments, a first STA may intend to transmit to a second STA via a third STA, where the third STA acts as a relay node between the first STA and the second STA. If the first STA sends a request to the third STA to establish a power saving schedule for communication with the third STA, then upon receiving the request frame, the third STA can send a response frame to the first STA. In some embodiments, the response frame may indicate whether the third STA agrees with the suggested schedule, rejects the suggested schedule or suggests an alternative schedule.

In some embodiments, a first STA may intend to transmit to a second STA via a third STA, where the third STA acts as a relay node between the first STA and the second STA. If the first STA sends a request to the third STA to establish a TWT schedule for communication with the third STA, then upon receiving the request frame, the third STA can send a response frame to the first STA. In some embodiments, the response frame may indicate whether the third STA agrees with the suggested TWT schedule, rejects the suggested TWT schedule or suggests an alternative TWT schedule.

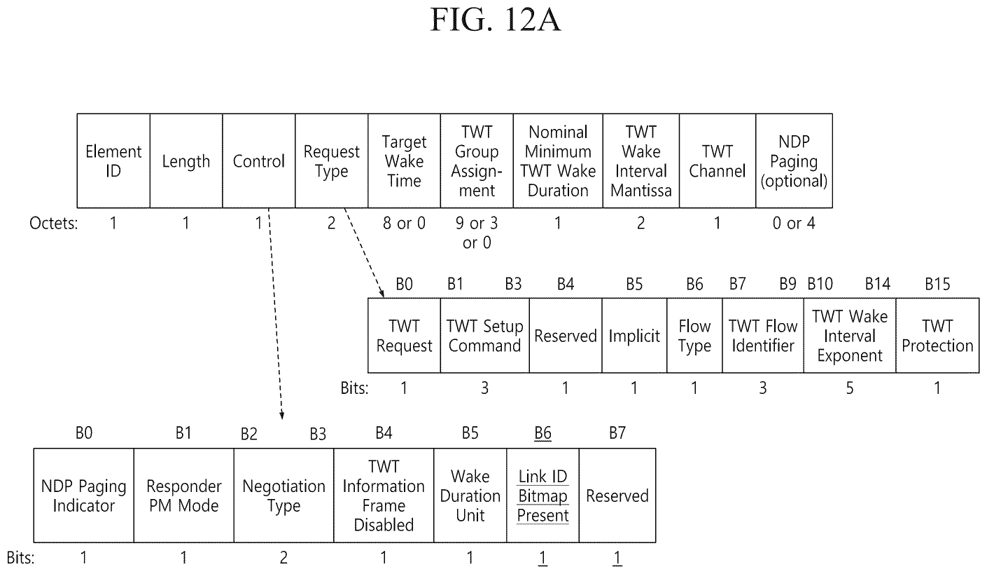

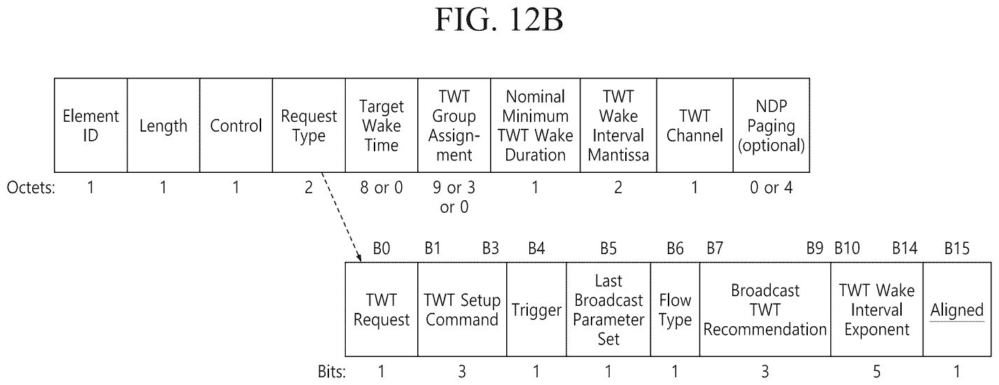

In some embodiments, the request can be sent as a TWT Setup frame with the TWT Setup Command field set as Request TWT or Suggest TWT, as described with reference to FIG. 12A and FIG. 12B below. In certain embodiments, the response frame can be sent as a TWT Setup frame with the TWT Setup Command field value set to Accept TWT, Reject TWT, Alternate TWT, among other values.

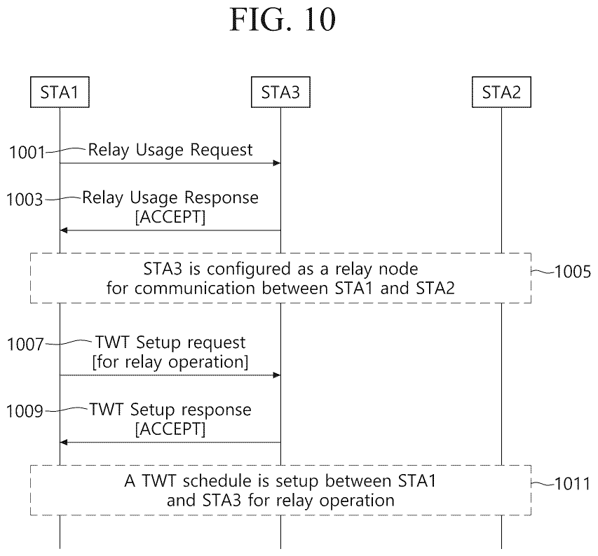

FIG. 10 illustrates an example of setting up a power saving schedule between a STA and a relay node in accordance with an embodiment. In particular, FIG. 10 illustrates communication between STA1 (e.g., source node), STA2 (e.g., destination node) and STA3 (e.g., relay node). Although one or more operations are described or shown in particular sequential order, in other embodiments the operations may be rearranged in a different order, which may include performance of multiple operations in at least partially overlapping time periods.

In operation 1001, STA1 transmits to STA3 a relay usage request. In some embodiments, the relay usage request may request that STA3 operates as a relay node between STA1 and STA2.

In operation 1003, STA3 transmits to STA1 a relay usage response indicating acceptance to operate as a relay node between STA1 and STA2.

In operation 1005, STA3 is configured as a relay node for communication between STA1 and STA2.

In operation 1007, STA1 transmits to STA3 a TWT setup request for relay operation. In some embodiments, the TWT setup request may include a TWT element that includes parameters for information pertaining to the TWT schedule that the STA1 intends to establish for communication via the STA3 (e.g., relay node). In some embodiments, the request can be sent as a TWT Setup frame with the TWT Setup Command field set as Request TWT or Suggest TWT.

In operation 1009, STA3 transmits to STA1 a TWT setup response with an accept status. In some embodiments, STA3 can send a response frame to STA1 where the response frame may indicate a different status, such as STA3 rejects the suggested TWT schedule or suggests an alternative TWT schedule. In some embodiments, the response frame can be sent as a TWT Setup frame with the TWT Setup Command field value set to Accept TWT, Reject TWT, Alternate TWT, among other values.

In operation 1011, a TWT schedule is set up between STA1 and STA3 for relay operation. In some embodiments, the STA3 may have a separate schedule for UL and DL operation and relaying operation. In particular, STA3 may have one TWT schedule established that it uses for relaying operation and another TWT schedule that it uses for UL and DL operation with STA1.

In some embodiments, a first STA may intend to communicate with a second STA via a third STA, where the third STA works as a relay node between the first STA and the second STA. The first STA may send a first request to setup a first power saving schedule with the third STA. Then upon receiving the request from the first STA, the third STA can send a second request to set up a second power saving schedule with the second STA. In some embodiments, the parameters for the first schedule and the second schedule may be different. In certain embodiments, the parameters for the first schedule and the second schedule can be the same. In some embodiments, the first schedule and the second schedule can be aligned schedules.

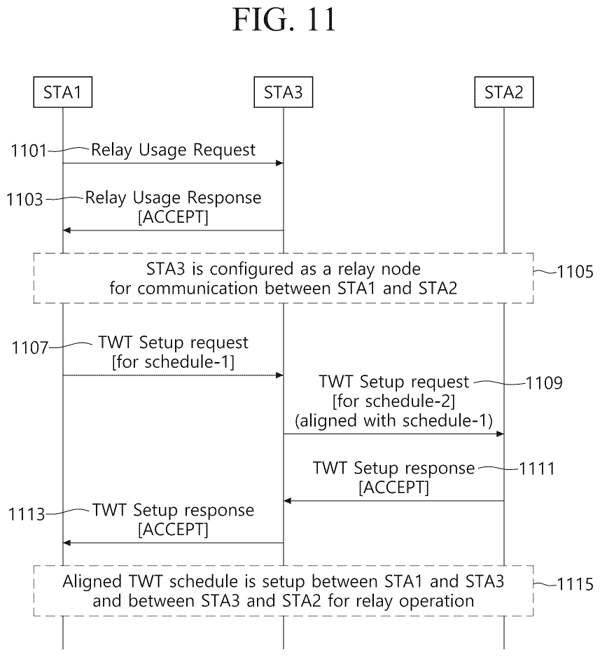

FIG. 11 illustrates an example of aligned schedule setup for relay operation in accordance with an embodiment. In particular, FIG. 11 illustrates communication between STA1 (e.g., source node), STA2 (e.g., destination node) and STA3 (e.g., relay node). Although one or more operations are described or shown in particular sequential order, in other embodiments the operations may be rearranged in a different order, which may include performance of multiple operations in at least partially overlapping time periods

In operation 1101, STA1 transmits to STA3 a relay usage request. In some embodiments, the relay usage request may request that STA3 operates as a relay node between STA1 and STA2.

In operation 1103, STA3 transmits to STA1 a relay usage response indicating acceptance to operate as a relay node between STA1 and STA2.

In operation 1105, STA3 is configured as a relay node for communication between STA1 and STA2.

In operation 1107, STA1 transmits to STA3 a TWT setup request for schedule-1. In some embodiments, the TWT setup request may include a TWT element that includes parameters for information pertaining to the TWT schedule that the STA1 intends to establish for communication via the STA3 (e.g., relay node).

In operation 1109, STA3 transmits to STA2 a TWT setup request for schedule-2, which is aligned with schedule-1. In some embodiments, the parameters for the schedule-1 and schedule-2 can be the same, and thus the schedule-1 and schedule-2 may be aligned schedules. In some embodiments, the parameters for schedule-1 and schedule-2 may be different.

In operation 1111, STA2 transmits to STA3 a TWT setup response with an accept status.

In operation 1113, STA3 transmits to STA1 a TWT Setup response with an accept status. In some embodiments, the STA3 can send a response frame to the STA1 where the response frame may indicate a different status, such as STA3 rejects the suggested TWT schedule or suggests an alternative TWT schedule. In some embodiments, the response frame can be sent as a TWT Setup frame with the TWT Setup Command field value set to Accept TWT, Reject TWT, Alternate TWT, among other values.

In operation 1115, an aligned TWT schedule is set up between STA1 and STA3 and between STA3 and STA2 for relay operation.

FIG. 12A shows an example of a TWT element in accordance with an embodiment. The TWT element 1000 may be applicable to IEEE 802.11be standard and any future amendments to the IEEE standard. The TWT element may be included in a broadcast frame, such as a beacon frame, an association response frame, a reassociation response frame, or a probe response frame, transmitted by APs affiliated with the AP MLD.

Details about each field and subfields of the TWT element are further explained below. In FIG. 12A, the TWT element may include an Element identifier (ID) field, a length field, a Control field, a Request Type filed, a Target Wake Time field, a TWT Group Assignment field, a Nominal Minimum TWT Wake Duration field, a TWT Wake Interval Mantissa field, a TWT Channel field, and a NPD Paging (optional) field.

The Element ID field may include information to identify the TWT element. The Length field may indicate a length of the TWT element.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and a Reserved subfield. The NDP Paging Indicator subfield may indicate whether an NDP paging field is present or not in an Individual TWT Parameter Set field. The Responder PM Mode subfield may indicate the power management mode, such as active mode and power save (PS) mode. The Negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the TWT element 1000. The Link ID Bitmap Present subfield may indicate the presence of the Link ID Bitmap field in the TWT element. The TWT Parameter Information field of the TWT element 1000 may include either a single Individual TWT Parameter Set field or one or more Broadcast TWT Parameter Set fields 1020. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields.

The Request Type field will be explained in further detail below.

The Target Wake Time field may indicate the start time of the TWT service period (SP) on the corresponding link.

The Nominal Minimum TWT Wake Duration field may indicate the minimum amount of time that the TWT scheduled STA is expected to be awake in order to compete the frame exchanges for the period of TWT wake interval.

The TWT Wake Interval Mantissa field may indicate the value of the mantissa of the TWT wake interval value.

The TWT Channel field may provide channel information for the TWT.

The NPD Paging (optional) field may provide NPD paging information.

The Request Type field may include a TWT Request subfield, a TWT Setup Command subfield, a reserved subfield, an Implicit subfield, a Flow Type subfield, a TWT Flow Identifier subfield, a TWT Wake Interval Exponent subfield, and a TWT Protection subfield.

The TWT Request subfield may indicate if the transmitting STA is a TWT scheduling AP (or STA) or a TWT scheduled STA (or AP). The TWT Setup Command subfield may indicate the type of TWT command such as Request TWT, Suggest TWT, Demand TWT, TWT Grouping, Accept TWT, Alternate TWT, Dictate TWT and Reject TWT. The Reserved subfield may be a reserved field. The Implicit subfield may be used for an implicit TWT agreement. The Flow Type subfield may indicate the type of interaction, for example, an announced TWT or an unannounced TWT between the TWT scheduled STA and the TWT scheduling AP at TWT. The TWT Flow Identifier subfield may be used to provide a TWT flow identifier. The TWT Wake Interval Exponent may indicate the value of the exponent of the TWT wake interval value. The TWT Protection subfield may be used to protect the TWT element.

FIG. 12B illustrates another example of a TWT element in accordance with an embodiment. Many of the fields illustrated in FIG. 12B are the same as those provided in FIG. 12A. The Request Type field may include a TWT Request field, a TWT Setup Command field, a Trigger field, a Last Broadcast Parameter Set field, a Flow Type field, A Broadcast TWT Recommendation field, a TWT Wake Interval Exponent field, and an Aligned field. The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links.

Embodiments in accordance with this disclosure may provide mechanisms to establish a power saving schedule with a relay node, to thereby improve a battery-life of a relay node and/or the power consumption of the relay node. Embodiments in accordance with this disclosure may provide mechanisms that may use one or more relay nodes to increase the signal to noise ratio (SNR) for STAs that may be suffering from bad signal strength in order to improve their throughput and rate.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to:
transmit, to a second STA, a first frame that requests the second STA operate as a relay node that relays communication between the first STA and a third STA;
receive, from the second STA, a second frame that accepts the request in the first frame;
transmit, to the second STA, a third frame that includes a request for a setup of a target wake time (TWT) schedule or a TWT agreement between the first STA and the second STA;
receive, from the second STA, a fourth frame that accepts the request in the third frame; and
transmit, to the third STA via the second STA, one or more frames based on the TWT schedule or the TWT agreement established between the first STA and the second STA.

2. The first STA of claim 1, wherein the third frame includes a TWT element that includes one or more parameters of the TWT schedule or the TWT agreement that the first STA intends to establish for communication with the third STA via the second STA.

3. The first STA of claim 1, wherein the TWT schedule is aligned with another TWT schedule that is established between the second STA and the third STA.

4. The first STA of claim 3, wherein TWT parameters for the TWT schedule and the another TWT schedule are the same.

5. The first STA of claim 3, wherein TWT parameters for the TWT schedule and the another TWT schedule are different.

6. The first STA of claim 1, wherein the processor is further configured to abstain from transmitting any frames to the third STA via the second STA during a doze state of the TWT schedule or the TWT agreement.

7. A first station (STA) in a wireless network, comprising:
a memory; and
a processor coupled to the memory, the processor configured to:
receive, from a second STA, a first frame that requests the first STA operate as a relay node that relays communication between the second STA and a third STA;
transmit, to the second STA, a second frame that accepts the request in the first frame;
receive, from the second STA, a third frame that includes a request for a setup of a target wake time (TWT) schedule or a TWT agreement between the second STA and the first STA;
transmit, to the second STA, a fourth frame that accepts the request in the third frame; and
relay, to the third STA, one or more frames received from the second STA based on the TWT schedule or the TWT agreement established between the first STA and the second STA.

8. The first STA of claim 7, wherein the third frame includes a TWT element that includes one or more parameters of the TWT schedule or the TWT agreement that the second STA intends to establish for communication with the third STA via the first STA.

9. The first STA of claim 7, wherein the processor is further configured to:
transmit, to the third STA, a fifth frame that include a request of a setup of another TWT schedule or another TWT agreement between the first STA and the third STA;
receive, from the third STA, a sixth frame that accepts the request in the fifth frame; and
transmit, to the third STA, one or more frames based on the another TWT schedule or the another TWT agreement.

10. The first STA of claim 9, wherein the TWT schedule is aligned with the another TWT schedule.

11. The first STA of claim 9, wherein TWT parameters for the TWT schedule and the another TWT schedule are the same.

12. The first STA of claim 9, wherein TWT parameters for the TWT schedule and the another TWT schedule are different.

13. The first STA of claim 7, wherein the processor is further configured to:
receive, from the second STA, a fifth frame that includes a request of a setup of another TWT schedule or another TWT agreement between the second STA and the first STA for uplink (UL) or downlink (DL) operation;
transmit, to the second STA, a sixth frame that accepts the request in the fifth frame;
transmit, to the second STA, one or more frames based on the another TWT schedule or another TWT agreement for UL or DL operation.

14. The first STA of claim 7, wherein the processor is further configured to abstain from transmitting any frames to the third STA during a doze state of the TWT schedule or the TWT agreement.

15. A computer-implemented method for wireless communication by a first station (STA) in a wireless network, comprising:
transmitting, to a second STA, a first frame that requests the second STA operate as a relay node that relays communication between the first STA and a third STA;
receiving, from the second STA, a second frame that accepts the request in the first frame;
transmitting, to the second STA, a third frame that includes a request for a setup of a target wake time (TWT) schedule or a TWT agreement between the first STA and the second STA;
receiving, from the second STA, a fourth frame that accepts the request in the third frame; and
transmitting, to the third STA via the second STA, one or more frames based on the TWT schedule or the TWT agreement established between the first STA and the second STA.

16. The computer-implemented method of claim 15, wherein the third frame includes a TWT element that includes one or more parameters of the TWT schedule or the TWT agreement that the first STA indents to establish for communication with the third STA via the second STA.

17. The computer-implemented method of claim 15, wherein the TWT schedule is aligned with another TWT schedule that is established between the second STA and the third STA.

18. The computer-implemented method of claim 17, wherein TWT parameters for the TWT schedule and the another TWT schedule are the same.

19. The computer-implemented method of claim 17, wherein TWT parameters for the TWT schedule and the another TWT schedule are different.

20. The computer-implemented method of claim 15, further comprising abstaining from transmitting any frames to the third STA via the second STA during a doze state of the TWT schedule or the TWT agreement.
